(19) United States
(12) Patent Application Publication
(10) Pub. No.: US 2026/0036713 A1
(43) Pub. Date: Feb. 5, 2026

(54) REAL-TIME ACOUSTIC SOURCE LOCALIZATION VIA BAYESIAN BEAMFORMING

(71) Applicant: Halliburton Energy Services, Inc., Houston, TX (US)

(72) Inventors: Eduardo Alves da Silva, Rio de Janeiro (BR); Francisco Alirio Almeida Gomes de Moura, Rio de Janeiro (BR); Yadong Wang, Singapore (SG); Rafael March Castaneda Neto, Rio de Janeiro (BR); Mahmoud Helmy Ramadan Saada, Houston, TX (US)

(73) Assignee: Halliburton Energy Services, Inc., Houston, TX (US)

(21) Appl. No.: 18/788,943

(22) Filed: Jul. 30, 2024

(51) Int. Cl. G01V 1/50; G01V 1/18

(52) U.S. Cl. CPC G01V 1/50; G01V 1/186

(57) ABSTRACT

A method for acoustic noise source detection. The method may include disposing an acoustic logging tool into a wellbore, taking a first measurement at a first depth with the acoustic logging tool as the acoustic logging tool traverses down the wellbore, taking a second measurement at a second depth with the acoustic logging tool as the acoustic logging tool traverses down the wellbore, and forming a first noise source localization map based at least in part on the first measurement. The method may further include forming a second noise source localization map based at least in part on the second measurement and combining the first noise source localization map and the second noise source localization map to form a final enhanced noise source localization map.

### BACKGROUND

For oil and gas exploration and production, a network of wells, installations and other conduits may be established by connecting sections of metal pipe together. For example, a well installation may be completed, in part, by lowering multiple sections of metal pipe (i.e., a casing string) into a wellbore, and cementing the casing string in place. In some well installations, multiple casing strings are employed (e.g., a concentric multi-string arrangement) to allow for different operations related to well completion, production, or enhanced oil recovery (EOR) options.

A growing concern in the life of an oil or gas well is the pressure buildup in its annuli. Near wellbore fluid flows can be caused by leakages on casing or tubing, channels in the cement, fractures in the formation, or active reservoir. The knowledge of flow locations and distributions is critical for remedial and production management operations, e.g., repairing wellbore leakages, identifying water sources and sealing water entrances, re-perforating unactive production intervals, etc. Localizing the flows using an acoustic logging tool presents enormous challenge to petroleum engineers.

### BRIEF DESCRIPTION OF THE DRAWINGS

These drawings illustrate certain aspects of some examples of the present disclosure and should not be used to limit or define the disclosure.

FIG. 1 illustrates a system including an acoustic logging tool;

FIG. 2 illustrates an acoustic logging tool during measurement operations;

FIG. 3 illustrates a schematic of an information handling system;

FIG. 4 illustrates another schematic of the information handling system;

FIG. 5 illustrates an example of recording a sources with an acoustic logging tool;

FIGS. 6A-6C are graphs that illustrate an example of recording a distributed source with an acoustic logging tool; and

FIG. 7 illustrates an acoustic logging tool performing a beamforming operation to generate multiple beamforming maps of a region.

### DETAILED DESCRIPTION

This disclosure may generally relate to methods and systems for capturing and recording noise in a wellbore and determining the location of a noise source using an array of hydrophones. Currently, a triangulation method may be used to estimate the noise source location from the raw hydrophone waveforms. This method is called “Beamforming.” Beamforming may be performed by stopping at a certain depth of interest and recording “noise” with the hydrophones, saving the data in an acoustic logging tolls memory and post-processing the noise data. This is defined as “stationary logging.” The methods and systems disclosed below may utilize a Bayesian approach for fast beamforming calculations using the acoustic logging tool. This may allow the acoustic logging tool to be run in a wellbore during measurement operations, without stopping, while collecting waveforms and obtaining one or more low resolution beamforming maps. Using the Bayesian framework, these maps may be updated in real time to identify the noise source location.

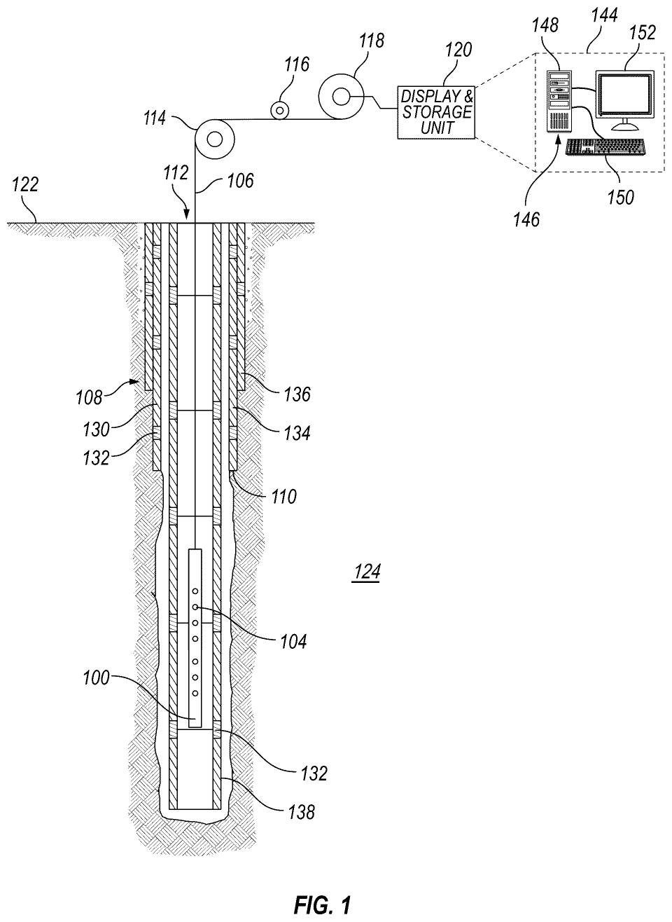

FIG. 1 illustrates an operating environment for an acoustic logging tool 100 as disclosed herein in accordance with particular embodiments. Acoustic logging tool 100 may comprise a hydrophone 104. In examples, there may be any number of hydrophones 104, which may be disponed on acoustic logging tool 100. Acoustic logging tool 100 may be operatively coupled to a conveyance 106 (e.g., wireline, slickline, coiled tubing, pipe, downhole tractor, and/or the like) which may provide mechanical suspension, as well as electrical connectivity, for acoustic logging tool 100. Conveyance 106 and acoustic logging tool 100 may extend within casing string 108 to a desired depth within wellbore 110. Conveyance 106, which may include one or more electrical conductors, may exit wellhead 112, may pass around pulley 114, may engage odometer 116, and may be reeled onto winch 118, which may be employed to raise and lower the tool assembly in wellbore 110. Signals recorded by acoustic logging tool 100 may be stored on memory and then processed by display and storage unit 120 after recovery of acoustic logging tool 100 from wellbore 110. Alternatively, signals recorded by acoustic logging tool 100 may be conducted to display and storage unit 120 by way of conveyance 106. Display and storage unit 120 may process the signals, and the information contained therein may be displayed for an operator to observe and stored for future processing and reference. Alternatively, signals may be processed downhole prior to receipt by display and storage unit 120 or both downhole and at surface 122, for example, by display and storage unit 120. Display and storage unit 120 may also contain an apparatus for supplying control signals and power to acoustic logging tool 100. Typical casing string 108 may extend from wellhead 112 at or above ground level to a selected depth within a wellbore 110. Casing string 108 may comprise a plurality of joints 130 or segments of casing string 108, each joint 130 being connected to the adjacent segments by a collar 132. There may be any number of layers in casing string 108. For example, a first casing 134 and a second casing 136. It should be noted that there may be any number of casing layers.

FIG. 1 also illustrates a typical pipe string 138, which may be positioned inside of casing string 108 extending part of the distance down wellbore 110. Pipe string 138 may be production tubing, tubing string, casing string, or other pipe disposed within casing string 108. Pipe string 138 may comprise concentric pipes. It should be noted that concentric pipes may be connected by collars 132. Acoustic logging tool 100 may be dimensioned so that it may be lowered into the wellbore 110 through pipe string 138, thus avoiding the difficulty and expense associated with pulling pipe string 138 out of wellbore 110.

In logging systems, such as, for example, logging systems utilizing the acoustic logging tool 100, a digital telemetry system may be employed, wherein an electrical circuit may be used to both supply power to acoustic logging tool 100 and to transfer data between display and storage unit 120 and acoustic logging tool 100. A DC voltage may be provided to acoustic logging tool 100 by a power supply located above ground level, and data may be coupled to the DC power conductor by a baseband current pulse system. Alternatively, acoustic logging tool 100 may be powered by batteries located within the downhole tool assembly, and/or the data provided by acoustic logging tool 100 may be stored within the downhole tool assembly, rather than transmitted to the surface during logging (corrosion detection).

As illustrated, one or more hydrophones 104 may be positioned on the acoustic logging tool 100. It should be understood that the configuration of acoustic logging tool 100 shown on FIG. 1 is merely illustrative and other configurations of acoustic logging tool 100 may be used with the present techniques. Hydrophone 104 may include any suitable acoustic receiver suitable for use downhole, including piezoelectric elements that may convert acoustic waves into an electric signal or hydrophones. Additionally, hydrophone 104 may be able to record any waves generated by leakage or other flow event inside and/or outside of the wellbore. In examples, hydrophone 104 may be disposed at any suitable location on acoustic logging tool 100. For example, hydrophones 104 may be disposed along the outer edge of acoustic logging tool 100 or within acoustic logging tool 100. Additionally, hydrophones 104 may be stacked along the longitudinal axis of acoustic logging tool 100 and/or one or more hydrophones 104 may be disposed circumferentially in a plane perpendicular to the longitudinal axis of acoustic logging tool 100.

Referring back to FIG. 1, the recordation of signals by hydrophones 104 may be controlled by display and storage unit 120, which may include an information handling system 144. As illustrated, the information handling system 144 may be a component of the display and storage unit 120. Alternatively, the information handling system 144 may be a component of acoustic logging tool 100. An information handling system 144 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price. Information handling system 144 may include a processing unit 146 (e.g., microprocessor, central processing unit, etc.) that may process EM log data by executing software or instructions obtained from a local non-transitory computer readable media 148 (e.g., optical disks, magnetic disks). The non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also include input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with acoustic logging tool 100 and/or software executed by processing unit 146. For example, information handling system 144 may enable an operator to select analysis options, view collected log data, view analysis results, and/or perform other tasks.

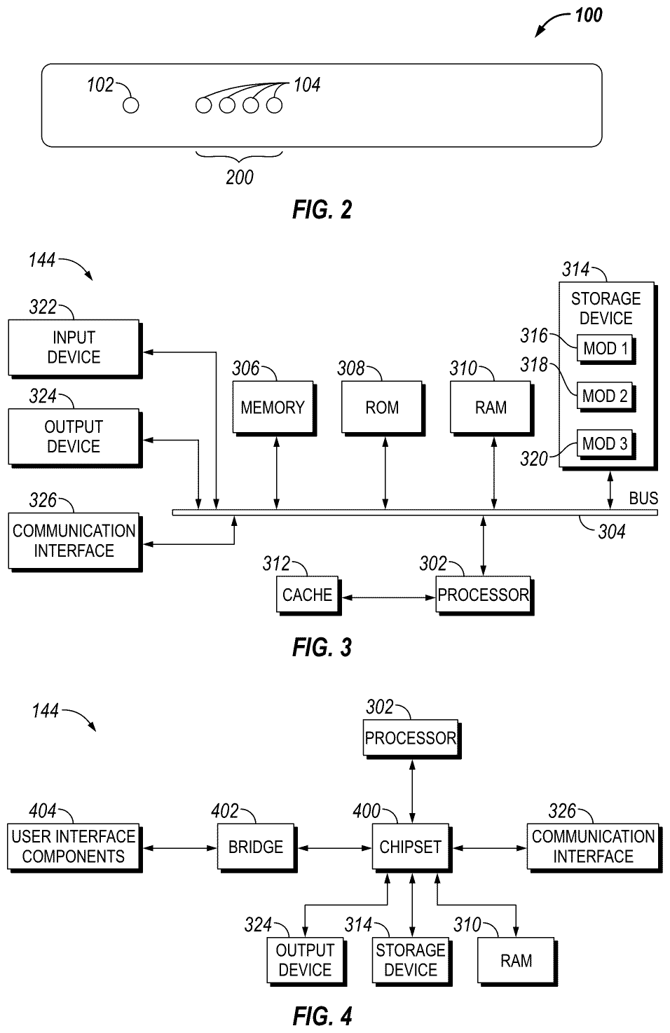

FIG. 2 illustrates a schematic layout of acoustic logging tool 100. As illustrated, acoustic logging tool 100 may comprise a transmitter 102 and an array 200 of hydrophones 104. It should be noted that acoustic logging tool 100 may comprise one or more arrays 200 disposed on one or more acoustic logging tools 100 on a wireline. In examples, transmitters 102 may be a directional transmitter and/or a unipole source. In other examples, transmitter 102 may be replaced by an array of transmitters 102 that may use beamforming techniques to create one or more focused acoustic beams. Hydrophones 104 may include a segmented piezoelectric tube, individual receiver, or azimuthal receiver array, which may produce azimuthal variation of bonding behind casing string 108 (e.g., referring to FIG. 1). In examples, array 200 may be disposed above or below transmitter 102. Additionally, the spacing between each hydrophone 104 within array 200 may be the same or different. Further, hydrophone 104 may be positioned to create a non-linear array along the axis of acoustic logging tool 100. Generally, during operations, transmitter 102 may emit one or more acoustic waves with may interact with borehole structures, such as tubing, casing string 108, borehole fluid, and/or acoustic logging tool 100 (e.g., referring to FIG. 1). The signal waves that have interacted with borehole structures may then be acquired by one or more hydrophones 104 within array 200.

Referring back to FIG. 1, transmission of acoustic waves by transmitter 102 and the recordation of signals by hydrophones 104 may be controlled by display and storage unit 120, which may include an information handling system 144. As illustrated, the information handling system 144 may be a component of the display and storage unit 120. Alternatively, the information handling system 144 may be a component of acoustic logging tool 100. An information handling system 144 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 144 may be a personal computer, a network storage device, or any other suitable device and may vary in size, shape, performance, functionality, and price. Information handling system 144 may include a processing unit 146 (e.g., microprocessor, central processing unit, etc.) that may process EM log data by executing software or instructions obtained from a local non-transitory computer readable media 148 (e.g., optical disks, magnetic disks). Non-transitory computer readable media 148 may store software or instructions of the methods described herein. Non-transitory computer readable media 148 may include any instrumentality or aggregation of instrumentalities that may retain data and/or instructions for a period of time. Non-transitory computer readable media 148 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 144 may also include input device(s) 150 (e.g., keyboard, mouse, touchpad, etc.) and output device(s) 152 (e.g., monitor, printer, etc.). The input device(s) 150 and output device(s) 152 provide a user interface that enables an operator to interact with acoustic logging tool 100 and/or software executed by processing unit 146. For example, information handling system 144 may enable an operator to select analysis options, view collected log data, view analysis results, and/or perform other tasks.

FIG. 3 illustrates an example information handling system 144 which may be employed to perform various steps, methods, and techniques disclosed herein. As illustrated, information handling system 144 includes a processing unit (CPU or processor) 302 and a system bus 304 that couples various system components including system memory 306 such as read only memory (ROM) 308 and random-access memory (RAM) 310 to processor 302. Processors disclosed herein may all be forms of this processor 302. Information handling system 144 may include a cache 312 of high-speed memory connected directly with, in close proximity to, or integrated as part of processor 302. Information handling system 144 copies data from memory 306 and/or storage device 314 to cache 312 for quick access by processor 302. In this way, cache 312 provides a performance boost that avoids processor 302 delays while waiting for data. These and other modules may control or be configured to control processor 302 to perform various operations or actions. Other system memory 306 may be available for use as well. Memory 306 may include multiple different types of memory with different performance characteristics. It may be appreciated that the disclosure may operate on information handling system 144 with more than one processor 302 or on a group or cluster of computing devices networked together to provide greater processing capability. Processor 302 may include any general purpose processor and a hardware module or software module, such as first module 316, second module 318, and third module 320 stored in storage device 314, configured to control processor 302 as well as a special-purpose processor where software instructions are incorporated into processor 302. Processor 302 may be a self-contained computing system, containing multiple cores or processors, a bus, memory controller, cache, etc. A multi-core processor may be symmetric or asymmetric. Processor 302 may include multiple processors, such as a system having multiple, physically separate processors in different sockets, or a system having multiple processor cores on a single physical chip. Similarly, processor 302 may include multiple distributed processors located in multiple separate computing devices but working together such as via a communications network. Multiple processors or processor cores may share resources such as memory 306 or cache 312 or may operate using independent resources. Processor 302 may include one or more state machines, an application specific integrated circuit (ASIC), or a programmable gate array (PGA) including a field PGA (FPGA).

The information handling system 144 may comprise a processor 302 that executes one or more instructions for processing the one or more measurements. The information handling system 144 may comprise processor 302 that executes one or more instructions for processing the one or more measurements. Information handling system 144 may process one or more measurements according to any one or more algorithms, functions, or calculations discussed below. In one or more embodiments, the information handling system 144 may output a signal wave.

Processor 302 may include, for example a microprocessor, microcontroller, digital signal processor (DSP), application specific integrated circuit (ASIC), or any other digital or analog circuitry configured to interpret, execute program instructions, process data, or any combination thereof. Processor 302 may be configured to interpret and execute program instructions or other data retrieved and stored in any memory such as memory 306 or cache 312. Program instructions or other data may constitute portions of a software or application for carrying out one or more methods described herein. memory 306 or cache 312 may comprise read-only memory (ROM), random access memory (RAM), solid state memory, or disk-based memory. Each memory module may include any system, device or apparatus configured to retain program instructions, program data, or both for a period of time (e.g., computer-readable non-transitory media). For example, instructions from a software or application may be retrieved and stored in memory 306 for execution by processor 302.

Each individual component discussed above may be coupled to system bus 304, which may connect each and every individual component to each other. System bus 304 may be any of several types of bus structures including a memory bus or memory controller, a peripheral bus, and a local bus using any of a variety of bus architectures. A basic input/output (BIOS) stored in ROM 308 or the like, may provide the basic routine that helps to transfer information between elements within information handling system 144, such as during start-up. Information handling system 144 further includes storage devices 314 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 314 may include software modules 316, 318, and 320 for controlling processor 302. Information handling system 144 may include other hardware or software modules. Storage device 314 is connected to the system bus 304 by a drive interface. The drives and the associated computer-readable storage devices provide nonvolatile storage of computer-readable instructions, data structures, program modules and other data for information handling system 144. In one aspect, a hardware module that performs a particular function includes the software component stored in a tangible computer-readable storage device in connection with the necessary hardware components, such as processor 302, system bus 304, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 144 is a small, handheld computing device, a desktop computer, or a computer server. When processor 302 executes instructions to perform “operations”, processor 302 may perform the operations directly and/or facilitate, direct, or cooperate with another device or component to perform the operations.

As illustrated, information handling system 144 employs storage device 314, which may be a hard disk or other types of computer-readable storage devices which may store data that are accessible by a computer, such as magnetic cassettes, flash memory cards, digital versatile disks (DVDs), cartridges, random access memories (RAMs) 310, read only memory (ROM) 308, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 144, an input device 322 represents any number of input mechanisms, such as a microphone for speech, a touch-sensitive screen for gesture or graphical input, keyboard, mouse, motion input, speech and so forth. Additionally, input device 322 may take in data from one or more sensors, such as hydrophones 104, discussed above. An output device 324 may also be one or more of a number of output mechanisms known to those of skill in the art. In some instances, multimodal systems enable a user to provide multiple types of input to communicate with information handling system 144. Communications interface 326 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 302, that is purpose-built to operate as an equivalent to software executing on a general-purpose processor. For example, the functions of one or more processors presented in FIG. 3 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 308 for storing software performing the operations described below, and random-access memory (RAM) 310 for storing results. Very large-scale integration (VLSI) hardware embodiments, as well as custom VLSI circuitry in combination with a general-purpose DSP circuit, may also be provided.

The logical operations of the various methods, described below, are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. Information handling system 144 may practice all or part of the recited methods, may be a part of the recited systems, and/or may operate according to instructions in the recited tangible computer-readable storage devices. Such logical operations may be implemented as modules configured to control processor 302 to perform particular functions according to the programming of software modules 316, 318, and 320.

In examples, one or more parts of the example information handling system 144, up to and including the entire information handling system 144, may be virtualized. For example, a virtual processor may be a software object that executes according to a particular instruction set, even when a physical processor of the same type as the virtual processor is unavailable. A virtualization layer or a virtual “host” may enable virtualized components of one or more different computing devices or device types by translating virtualized operations to actual operations. Ultimately however, virtualized hardware of every type is implemented or executed by some underlying physical hardware. Thus, a virtualization computer layer may operate on top of a physical computer layer. The virtualization computer layer may include one or more virtual machines, an overlay network, a hypervisor, virtual switching, and any other virtualization application.

FIG. 4 illustrates another example information handling system 144 having a chipset architecture that may be used in executing the described method and generating and displaying a graphical user interface (GUI). Information handling system 144 is an example of computer hardware, software, and firmware that may be used to implement the disclosed technology. Information handling system 144 may include a processor 302, representative of any number of physically and/or logically distinct resources capable of executing software, firmware, and hardware configured to perform identified computations. Processor 302 may communicate with a chipset 400 that may control input to and output from processor 302. In this example, chipset 400 outputs information to output device 324, such as a display, and may read and write information to storage device 314, which may include, for example, magnetic media, and solid-state media. Chipset 400 may also read data from and write data to RAM 310. A bridge 402 for interfacing with a variety of user interface components 404 may be provided for interfacing with chipset 400. Such user interface components 404 may include a keyboard, a microphone, touch detection and processing circuitry, a pointing device, such as a mouse, and so on. In general, inputs to information handling system 144 may come from any of a variety of sources, machine generated and/or human generated.

Chipset 400 may also interface with one or more communication interfaces 326 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 302 analyzing data stored in storage device 314 or RAM 310. Further, information handling system 144 receives inputs from a user via user interface components 404 and executes appropriate functions, such as browsing functions by interpreting these inputs using processor 302.

In examples, information handling system 144 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. Using the systems and methods described above, acoustic logging tool 100 in conjunction with information handling system 144 may be utilized for well imaging. Well imaging may allow for the creation of a wellbore image that shows the location of casing string 108 relative to acoustic logging tool 100. Further cement evaluation may also be undertaken to evaluate the cement bond condition between casing string 108 and formation 124 (e.g., referring to FIG. 1). To perform well imaging and cement evaluation, beamforming methods and systems may be utilized.

Beamforming is a spatial filter for waves arriving from any direction of interest. This may be performed by a plurality of hydrophones 104 (e.g., referring to FIG. 2) that may take multiple spatial acquisition of a sound field. To apply the beamforming technique, it is necessary to choose an acoustic mode beforehand. For this disclosure, two forms of acoustics modes may be utilized, specular reflection beamforming and/or guided wave beamforming.

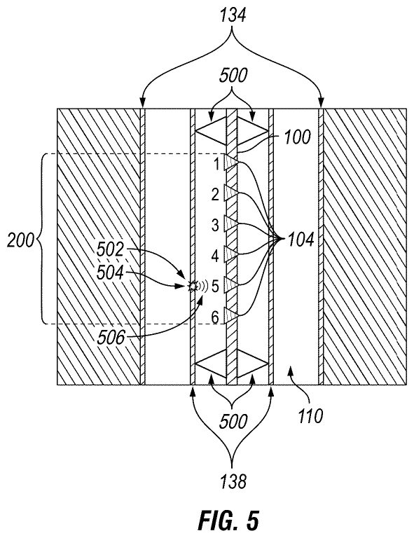

FIG. 5 illustrates acoustic logging tool 100 with array 200 in accordance with particular embodiments. Without limitation, there may be any number of hydrophones 104. As illustrated, array 200 includes a plurality of hydrophones 104 arranged longitudinally along the acoustic logging tool 100. During measurement operations, acoustic logging tool 100 may detect the depth and radial location of leak 502 and/or flow of fluid 504 in wellbore 110. In examples, acoustic logging tool 100 may be deployed with one or more stabilizers 500 installed above or below acoustic logging tool 100. As illustrated in FIG. 5, and discussed above, acoustic logging tool 100 may be disposed in pipe string 138, which may be disposed in a first casing 134. During operations, each hydrophone 104 of array 200 may sense and record any number of acoustic signals and/or vibrations continuously as acoustic logging tool 100 moves up or down wellbore 110 within pipe string 138. The recorded acoustic signals and/or vibrations may be identified as acoustic data. The acoustic data may be transmitted to information handling system 144, which may process each recorded acoustic signal with a beamforming algorithm to identify the location of the acoustic source. In examples, the acoustic source may be a leak 502 caused by flow of fluid 504 in leak 502. Fluid 504 may be flowing from outside pipe string 138 and into pipe string 138, or vice versa. Likewise, fluid 504 may be moving from outside of first casing 134 and into first casing 134, or vice versa. This is true for any casing that may be outside of first casing 134. The flow of fluid 504 between one or more pipe strings 138 and/or one or more casings may create acoustic noise 506 in leak 502. To properly process acoustic noise 506, beamforming may be used. Beamforming is a signal processing technique used in array 200 for directional signal transmission or reception. This is achieved by combining waveforms by a phased array in such a way that signals at particular angles experience constructive interference while others experience destructive interference.

The data recorded by acoustic logging tool 100 (e.g., referring to FIG. 1) may generally be referred to as an acoustic data set. To localize the noise sources with a beamforming type of technique, three or more hydrophones 104 may be utilized to capture and record acoustic noise 506 from the noise sources (i.e., leak 502), which is defined as noise data. Noise data, which may be captured in the acoustic data set, may be processed using information handling system 144, which may be communicatively connected to acoustic logging tool 100. Waveforms, which comprise the acoustic data set, are captured and recorded by received hydrophone 104. In examples, waveforms may originate from the noise source and may be noise waveforms that form noise data. The waveforms may be identified in Equation (1) as j and may be annotated as:

$${w}_{ij} ( t ) = A ( i ) \cdot {G}_{ij} ( t ) * {s}_{i} ( t ) \qquad ( 1 )$$

The noise source at location i may be represented as a function sᵢ(t). wᵢⱼ(t) is the waveform. A(i) is the source strength of the noise sources at location i. Gᵢⱼ(t) is the Green's function between the source i and receiver j. The * represents a convolution operation. The Green's function is determined by the acoustic property of the medium.

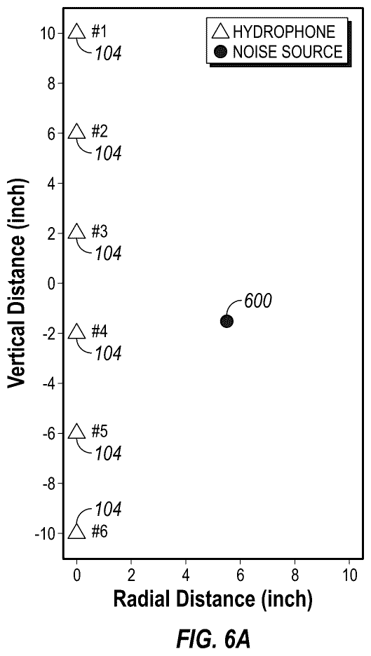

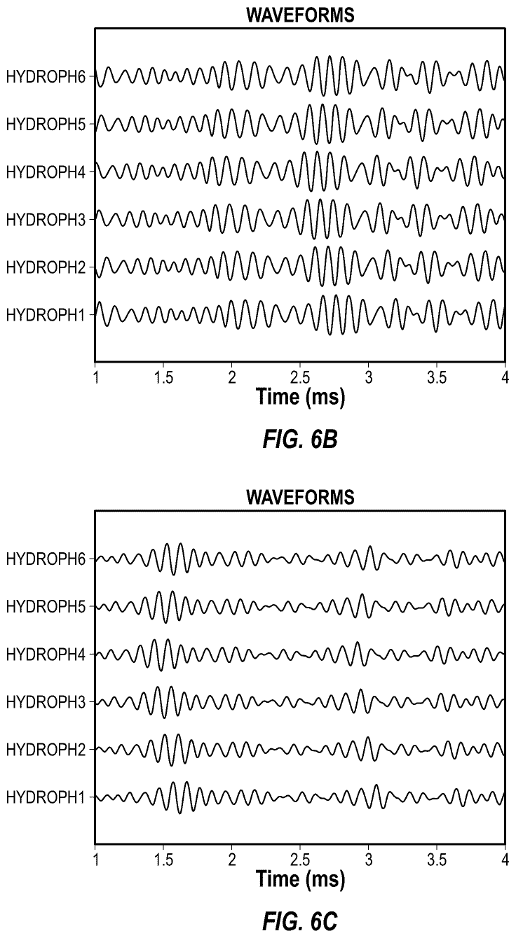

FIGS. 6A-6C are graphs illustrating measurement operations using six hydrophones 104 (e.g., referring to FIG. 2). FIG. 3A is a graph illustrating a location of the six hydrophones 104 and a noise source 600. FIG. 3B is a graph illustrating waveforms received by each of the six hydrophones 104 from a randomly generated white noise source filtered at 8-12 KHz. FIG. 6C is a graph illustrating waveforms received by each of the six hydrophones 104 from another randomly generated process. In this example, the noise source is a randomly generated Gaussian white noise. The waveforms may be filtered with an 8-12 kHz filter, using information handling system 144 (e.g., referring to FIG. 1), to simulate a noise source 600 at this frequency range. FIGS. 6A-6C disclose a traditional beamforming technique. Traditional beamforming techniques may generate a heatmap of possible positions of noise source 600.

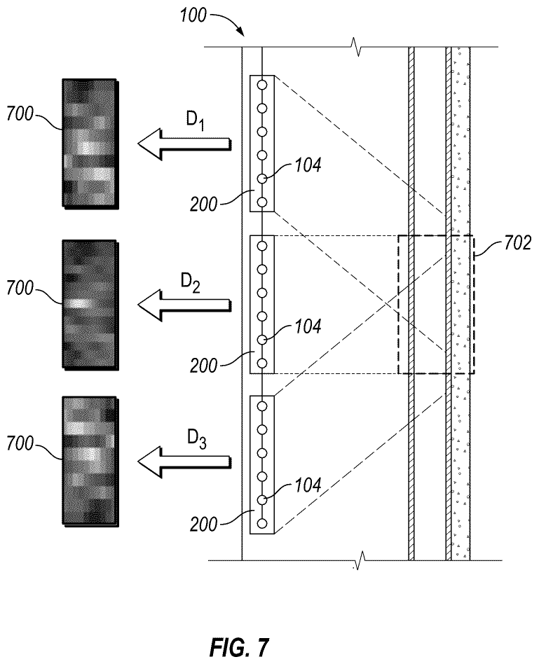

FIG. 7 illustrates acoustic logging tool 100 performing a measurement operation to generate a plurality of noise source localization maps 700 of a region 702, using the signals from hydrophones 104 at different acquisition depths. As illustrated, array 200 that is disposed on acoustic logging tool 100 may descend and collect data as signals in real time in wellbore 110 (e.g., referring to FIG. 1). Specifically, acoustic logging tool 100 may be moving when taking one or more measurements or may be stationary at a selected depth to take one or more measurements. For this disclosure, real time is defined as seconds and/or minutes. Thus, data may be captured and/or at least in part processed by information handling system 144 that may be at least in part disposed on acoustic logging tool 100 in seconds and/or minutes. Processing of the data may use beamforming methods and systems, described above, to create noise source localization maps 700. Additionally, data that is either processed or unprocessed may be transferred to the surface to information handling system 144 that may be disposed at least in part at the surface. Further, captured data may be processed to form noise source localization maps 700 using beamforming methods described above after the acoustic logging tool 100 has been removed from wellbore 110.

As noted above, signals collected for all hydrophones 104 may be used to generate noise source localization map 700 of region 702 using beamforming methods and systems described above. As illustrated, array 200 may take measurements at a first depth, D₁, a second depth D₂, a third depth, D₃, and/or as many depths as desired. At each depth, one or more noise source localization maps 700 may be generated. Each noise source localization map 700 may be interpreted as a statistical probability distribution. For example, a statistical probability distribution may be obtained by acquiring the power map obtained with the beamforming technique and normalizing it properly. The power map may be generated by evaluating the output power of the beamforming when steered to a certain location. Additionally, there may be one or more techniques that may be used to generate the beamforming maps, such as but not limited to Delay and Sum beamforming, Capon Beamforming, and/or MUSIC Beamforming.

Taking, for instance the Delay and Sum Beamformer, the calculations that may be used to derive noise source localization map 700 may be performed as follows. The beamformer map B(l, m) is a collection of L×M points. Each point(l, m) is associated with a coordinate in space (xᵢ, yₘ). Considering an array 200 of N hydrophones 104. Given the n-th hydrophone signal yₙ(t), and given that the time delay for a waveform emitted by a noise source 600 (e.g., referring to FIG. 6A) at position (xₗ, yₘ) to reach the n-th hydrophone 104 is t_{n,lm}, noise source localization map 700 generated by the delay and sum method is given by:

$${B}_{D \& S} ( l , m ) = {\vert \frac{1}{N} {\sum }_{n = 1}^{N} {y}_{n} ( t + {t}_{n , lm} ) \vert}^{2} \qquad ( 2 )$$

With continued reference to FIG. 7, after acoustic logging tool 100 has stopped descending, noise source localization map 700 may be combined (using a data combination strategy) to generate a final enhanced noise source localization map. The final enhanced noise source localization map may be combined utilizing a Bayesian method. The Bayesian method is a Bayesian inference approach with a uniform or non-uniform prior distribution for the noise source location. Many different combination strategies exist, such as but not limited to, Arithmetical Average, Geometric Average, a Pointwise Product, a Weighted Average, and/or a Normalized Product. As seen below, noise source localization map 700 generated at depth Zᵢ is given by Bⁱ. With a collection of l noise source localization map 700 and a prior distribution B⁰ which models prior knowledge regarding the distribution in hands. For example, this could encompass the knowledge from other sensors/other passes of the tool of a possible leak location, the data combination strategy produces a final beamforming map \tilde{B}(l,m). For example, using the normalized product strategy, a final beamforming map is given by:

$${\tilde{B}}^{NP} ( l , m ) = \frac{{\prod }_{i = 1}^{I} {B}^{i} ( l , m )}{{\sum }_{{l}^{′} , {m}^{′}} {\prod }_{{i}^{′} = 1}^{I} {B}^{{i}^{′}} ( {l}^{′} , {m}^{′} ) {B}^{0} ( {l}^{′} , {m}^{′} )} {B}^{0} ( l , m ) \qquad ( 3 )$$

Improvements over current technology may be found in that current acoustic tools perform acoustic measurements at certain depths, recording noise while stationary, saving the memory to the acoustic tools memory and post-processing the noise data. The utilization of a Bayesian method with a beamforming method may allow for faster and more reliable noise source localization. A Bayesian method is a Bayesian inference approach with a uniform or non-uniform prior distribution for the noise source location. The methods and systems described above improve accuracy, precision and robustness to noise. The systems and methods may include any of the various features disclosed herein, including one or more of the following statements.

Statement 1: A method for acoustic noise source detection may comprise disposing an acoustic logging tool into a wellbore, taking a first measurement at a first depth with the acoustic logging tool as the acoustic logging tool traverses down the wellbore, taking a second measurement at a second depth with the acoustic logging tool as the acoustic logging tool traverses down the wellbore, and forming a first noise source localization map based at least in part on the first measurement. The method may further comprise forming a second noise source localization map based at least in part on the second measurement and combining the first noise source localization map and the second noise source localization map to form a final enhanced noise source localization map.

Statement 2: The method of statement 1, wherein the final enhanced noise source localization map is formed at least in part from the first noise source localization map and the second noise source localization map using an Arithmetical Average, a Geometric Average, a Pointwise Product, or a prior distribution.

Statement 3: The method of any previous statements 1 or 2, wherein the acoustic logging tool comprises one or more hydrophones.

Statement 4: The method of statement 3, wherein two or more hydrophones form an array.

Statement 5: The method of statement 4, wherein the acoustic logging tool comprises one or more arrays.

Statement 6: The method of any previous statements 1, 2, or 3, wherein the first noise source localization map or the second noise source localization map are each a statistical probability distribution.

Statement 7: The method of any previous statements 1-3 or 6, wherein the first measurement is performed at the first depth and the second measurement is performed at the second depth when the acoustic logging tool is stationary in the wellbore at the first depth and at the second depth.

Statement 8: The method of any previous statements 1-3, 6, or 7, wherein the first measurement is performed at the first depth and the second measurement is performed at the second depth as the acoustic logging tool is traversing the wellbore.

Statement 9: The method of any previous statements 1-3 or 6-8, wherein the final enhanced noise source localization map is formed after the acoustic logging tool is removed from the wellbore.

Statement 10: The method of any previous statements 1-3 or 6-9, wherein the final enhanced noise source localization map is formed in real time as the acoustic logging tool is disposed in the wellbore.

Statement 11: A method for acoustic noise source detection may comprise disposing an acoustic logging tool into a wellbore, taking a first measurement at a first depth with the acoustic logging tool when the acoustic logging tool is stationary at the first depth in the wellbore, taking a second measurement at a second depth with the acoustic logging tool when the acoustic logging tool is stationary at the second depth in the wellbore, and forming a first noise source localization map based at least in part on the first measurement. The method may further comprise forming a second noise source localization map based at least in part on the second measurement and combining the first noise source localization map and the second noise source localization map to create a final enhanced noise source localization map.

Statement 12: The method of statement 11, wherein the first noise source localization map is formed using a Delay and Sum Beamforming, a Capon Beamforming, or a MUSIC Beamforming.

Statement 13: The method of any previous statements 11 or 12, wherein the final enhanced noise source localization map is formed at least in part from the first noise source localization map and the second noise source localization map using an Arithmetical Average, a Geometric Average, a Pointwise Product, or a prior distribution.

Statement 14: The method of any previous statements 11, 12, or 13, wherein the acoustic logging tool comprises one or more hydrophones.

Statement 15: The method of statement 14, wherein two or more hydrophones form an array.

Statement 16: The method of statement 15, wherein the acoustic logging tool comprises one or more arrays.

Statement 17: The method of any previous statements 11-13 or 16, wherein the first noise source localization map or the second noise source localization map are each a statistical probability distribution.

Statement 18: The method of any previous statements 11-13, 16, or 17, wherein the first measurement and the second measurement are performed in real time.

Statement 19: The method of any previous statements 11-13 or 16-18, wherein the final enhanced noise source localization map is formed after the acoustic logging tool is removed from the wellbore.

Statement 20: The method of any previous statements 11-13 or 16-19, wherein the final enhanced noise source localization map is formed in real time as the acoustic logging tool is disposed in the wellbore.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for acoustic noise source detection comprising:
disposing an acoustic logging tool into a wellbore;
taking a first measurement at a first depth with the acoustic logging tool as the acoustic logging tool traverses down the wellbore;
taking a second measurement at a second depth with the acoustic logging tool as the acoustic logging tool traverses down the wellbore;
forming a first noise source localization map based at least in part on the first measurement;
forming a second noise source localization map based at least in part on the second measurement; and
combining the first noise source localization map and the second noise source localization map to form a final enhanced noise source localization map.

2. The method of claim 1, wherein the final enhanced noise source localization map is formed at least in part from the first noise source localization map and the second noise source localization map using an Arithmetical Average, a Geometric Average, a Pointwise Product, or a prior distribution.

3. The method of claim 1, wherein the acoustic logging tool comprises one or more hydrophones.

4. The method of claim 3, wherein two or more hydrophones form an array.

5. The method of claim 4, wherein the acoustic logging tool comprises one or more arrays.

6. The method of claim 1, wherein the first noise source localization map or the second noise source localization map are each a statistical probability distribution.

7. The method of claim 1, wherein the first measurement is performed at the first depth and the second measurement is performed at the second depth when the acoustic logging tool is stationary in the wellbore at the first depth and at the second depth.

8. The method of claim 1, wherein the first measurement is performed at the first depth and the second measurement is performed at the second depth as the acoustic logging tool is traversing the wellbore.

9. The method of claim 1, wherein the final enhanced noise source localization map is formed after the acoustic logging tool is removed from the wellbore.

10. The method of claim 1, wherein the final enhanced noise source localization map is formed in real time as the acoustic logging tool is disposed in the wellbore.

11. A method for acoustic noise source detection comprising:
disposing an acoustic logging tool into a wellbore;
taking a first measurement at a first depth with the acoustic logging tool when the acoustic logging tool is stationary at the first depth in the wellbore;
taking a second measurement at a second depth with the acoustic logging tool when the acoustic logging tool is stationary at the second depth in the wellbore;
forming a first noise source localization map based at least in part on the first measurement;
forming a second noise source localization map based at least in part on the second measurement; and
combining the first noise source localization map and the second noise source localization map to create a final enhanced noise source localization map.

12. The method of claim 11, wherein the first noise source localization map is formed using a Delay and Sum Beamforming, a Capon Beamforming, or a MUSIC Beamforming.

13. The method of claim 11, wherein the final enhanced noise source localization map is formed at least in part from the first noise source localization map and the second noise source localization map using an Arithmetical Average, a Geometric Average, a Pointwise Product, or a prior distribution.

14. The method of claim 11, wherein the acoustic logging tool comprises one or more hydrophones.

15. The method of claim 14, wherein two or more hydrophones form an array.

16. The method of claim 15, wherein the acoustic logging tool comprises one or more arrays.

17. The method of claim 11, wherein the first noise source localization map or the second noise source localization map are each a statistical probability distribution.

18. The method of claim 11, wherein the first measurement and the second measurement are performed in real time.

19. The method of claim 11, wherein the final enhanced noise source localization map is formed after the acoustic logging tool is removed from the wellbore.

20. The method of claim 11, wherein the final enhanced noise source localization map is formed in real time as the acoustic logging tool is disposed in the wellbore.
